(19) United States
(12) Patent Application Publication
(10) Pub. No.: US 2012/0216370 A1
(43) Pub. Date: Aug. 30, 2012

(54) DAMPED DOOR HINGE

(76) Inventor: Chung Chow, Kowloon (CN)

(21) Appl. No.: 13/391,485

(22) PCT Filed: Apr. 26, 2010
(86) PCT No.: PCT/EP10/55559

§ 371 Date: May 7, 2012

(30) Foreign Application Priority Data
Aug. 18, 2009 (CN) 200920134872.1
Oct. 10, 2009 (CN) 200920205653.8
Apr. 21, 2010 (GB) 1006667.8

(51) Int. Cl. E05F 3/20; E05D 5/10; E05F 5/02

(52) U.S. Cl. 16/54; 16/50; 16/386

(57) ABSTRACT

A glass door hinge having an internal door stop arrangement comprises:
a housing;
a mount for coupling the housing to a support member;
a pair of clamps;
an axial spindle; and
a plurality of biasing members arranged to engage the spindle to return the clamps to one of a plurality of positions selected from a closed position and one or more opened positions;
wherein the spindle has a plurality of centering surfaces;
each biasing member being arranged to apply a force to a respective centering surface to centre the clamps in one or more of said positions.

### CROSS REFERENCE TO RELATED APPLICATIONS

This application is entitled to the benefit of and incorporates by reference essential subject matter disclosed in International Patent Application No. PCT/EP2010/055559 filed on Apr. 26, 2010, Chinese Patent Application No. 200920134872.1 filed Aug. 18, 2009, Chinese Patent Application No. 200920205653.8 filed Oct. 10, 2009, and United Kingdom Patent Application No. 1006667.8 filed Apr. 21, 2010.

### TECHNICAL FIELD

This invention relates to a hinge for a glass door, particularly but not exclusively for a frameless glass door.

### BACKGROUND OF THE INVENTION

Frameless glass doors require a door stop to locate the door in a closed position. Internal door stops have been disclosed, for example in U.S. Pat. No. 6,560,821.

### SUMMARY OF THE INVENTION

According to the present invention a glass door hinge having an internal door stop arrangement comprises:

a housing;

a mount for coupling the housing to a support member;

a pair of clamps;

an axial spindle; and

a plurality of biasing members arranged to engage the spindle to return the clamps to one of a plurality of positions selected from a closed position and one or more opened positions;

wherein the spindle has a plurality of centering surfaces;

each biasing member being arranged to apply a force to a respective centering surface to centre the clamps in one or more of said positions.

There are preferably two open positions perpendicular to the closed position.

The clamps may be adapted to securely engage a glass door panel. The glass panel may have holes to receive bolts passing through the clamps. Alternatively or in addition the clamps may engage the glass panel by friction or by use of an adhesive.

The hinge preferably includes damping means for damping the opening and closing movements of the hinge. Preferably the biasing means includes a damping arrangement to limit the rate of rotation of the hinge particularly from the opened to the closed position. The damping means may also limit the rate of rotation from a partially opened position to a fully opened position.

In preferred embodiments the hinge includes a main biasing member and a main spring arranged to engage a main centering surface to urge the door into a closed position; and a secondary biasing member and a secondary spring arranged to engage one of two secondary centering surfaces to urge the door into one of two opened positions.

The main and secondary biasing members are preferably located in horizontal bores arranged in vertically spaced relation extending radially relative to the spindle axis.

Preferably the two opened positions of the hinge are perpendicular to the closed position, and the two secondary centering surfaces are orthogonal to the main centering surface and are diametrically opposed. That is the secondary surfaces may be arranged to face in opposition directions perpendicular to the main centering surface.

The force of the main spring is preferably greater than the force of the secondary spring. In this way the hinge moves to the closed position unless the door is close to either of the opened positions. The hinge may comprise an overcentre arrangement wherein it moves either into the closed position or an open position when opened in either direction. The angular location of each centre point on each side of the closed position is preferably closed to the opened position.

The main spring may comprises a pair of concentric springs with extensions and extension forces selected to provide a constant rated closing of the door during rotation from an opened position to the closed position.

Each biasing member may comprise a piston mounted in a cylindrical bore for movement radially with respect to the spindle.

The piston preferably comprises a hollow cylindrical member having a head arranged to engage a respective centering surface, and having a cavity, a spring being located in the cavity within the cylindrical member to urge the piston outwardly of the bore.

The spindle may be mounted in a vertical guideway in the housing, the guideway communicating with passageways within which the biasing members are located to allow circulation of hydraulic fluid or other oil during actuation of the hinge.

The spindle preferably includes an attachment adapted to engage to the clamps. An end of the spindle may include a head configured to engage a socket in one of the clamps so that the spindle and clamps are constrained to rotate together.

According to a preferred aspect of the present invention a glass door hinge spindle comprises an axial shaft including an attachment for engagement to a door so that the spindle and door are constrained to rotate together in use;

wherein the spindle further comprises;

a main centering surface parallel to the axis of the shaft and two secondary centering surfaces orthogonal to the main centering surface;

wherein the two secondary centering surfaces extend axially of the shaft in diametrically opposed relation.

Preferably the spindle includes upper and lower bearing surfaces adapted to cooperate with bearings in the hinge body.

In a preferred embodiment the main centering surface is located below the secondary centering surfaces. Alternatively the main centering surface may be above the secondary surfaces.

Preferably a cylindrical collar surface is disposed between the main and secondary centering surfaces, the surface of the cylindrical collar being arranged to cooperate with an internal cylindrical surface of the hinge body to prevent deformation of the spindle in use.

Rotation of the spindle as the hinge is rotated causes retraction of one piston against the restoring force of the respective spring, but permits expansion of the other piston. Similarly when the hinge and door are approaching a closed or opened position, expansion of a piston under the action of its spring causes the door to continue rotation until it is fully centered in the opened or closed position.

The cavity within the piston is preferably filled with hydraulic fluid, for example lubricating oil.

The piston and cylindrical sleeve may each provide a damping arrangement. The piston and sleeve may be dimensioned to provide a sliding fit but substantially prevent escape of oil between their surfaces as the piston is compressed by rotation of the spindle. Therefore oil may be forced through a constricted channel to damp the movement of the hinge.

A channel may be provided to allow oil to pass from the piston cavity to a cavity within the housing as the piston is compressed into the cylindrical sleeve.

The channel may include an adjustable valve to regulate a maximum flow of oil. Adjustment of the valve allows the rate of closure of the hinge to be regulated so that the rotational movement of the hinge and door is damped in use.

A needle valve, having a screw thread may be provided to control the dimension of the passageway leading from the piston and cylinder into a passageway in the hinge housing.

Oil passing through the needle valve may be allowed to flow to a cavity between the spindle and the head of the piston.

In a preferred embodiment the piston of each biasing means includes a non-return valve arranged to permit a flow of oil into the cavity as the piston and cylinder expand. In this way oil is circulated from the cavity of the piston into a cavity between the piston and spindle and back into the piston cavity during the compression and expansion cycle of the piston. During this cycle the volume of the cavity available between the centering surface of the spindle and piston increases as the piston is compressed and decreases as the piston expands to fully engage the centering surface. This change in volume serves to pump oil through the non-return valve to cause circulation of the oil during opening and closing of the hinge and door. Circulation of the oil contributes to efficient clamping of the hinge.

The main piston may be provided with one or more apertures to allow a flow of oil from the cavity during initial compression of the piston.

In a preferred embodiment the piston has a head and a cylindrical body dimensioned to be slidably received within a cylindrical bore of the sleeve, and one or more apertures provided at a predetermined axial distance from the head, the aperture or apertures being blocked by the sleeve after sliding of the body by a predetermined distance into the cylindrical sleeve. In this arrangement oil can flow easily from the piston cavity until the piston has retracted to a predetermined extent, after which flow of oil is impeded or prevented, thereby providing a two speed damping effect.

A cut-away portion may be provided at the distal end of the cylindrical body of the piston to allow a flow of oil into the piston cavity as the piston is fully extended. At this stage the non-return valve in engagement with the centering surface of the spindle.

The hinge of this invention has several advantages. The opening and closing of the hinge are both damped by circulation of oil through the biasing means. This restricts slamming of a door during opening or closing. Such slamming may shatter a glass door or may cause injury. The extent of damping during closing can be controlled by adjustment of the valve in the secondary biasing means. Circulation of oil within the biasing means is promoted by the pumping action of rotation of the spindle.

### BRIEF DESCRIPTION OF THE DRAWINGS

This invention is further described by means of example but not in any limitative sense with reference to the accompanying drawings of which:

FIG. 1 is a perspective view of a first hinge in accordance with this invention;

FIG. 2 is an exploded view showing the components of the hinge;

FIG. 3 is a cross-sectional view of the hinge in the rest position;

FIG. 4 is a cross-sectional view of the hinge in the opened position;

FIG. 5 comprises various views of the spindle;

FIG. 6 is a cross-sectional view of the sleeve of the secondary biasing means;

FIG. 7 is a perspective view of the piston of the secondary biasing means;

FIG. 8 is a cross-sectional view of the sleeve for the main biasing means;

FIG. 9 is a perspective view of the main piston; and

FIGS. 10 to 14 show an alternative embodiment wherein FIGS. 10 to 14 correspond to FIGS. 2,3,4,6 and 7 to 9 respectively of the first embodiment.

### DETAILED DESCRIPTION OF THE PREFERRED EMBODIMENTS

In the description of the embodiments of the invention the same reference numerals are used to denote like components in each embodiment.

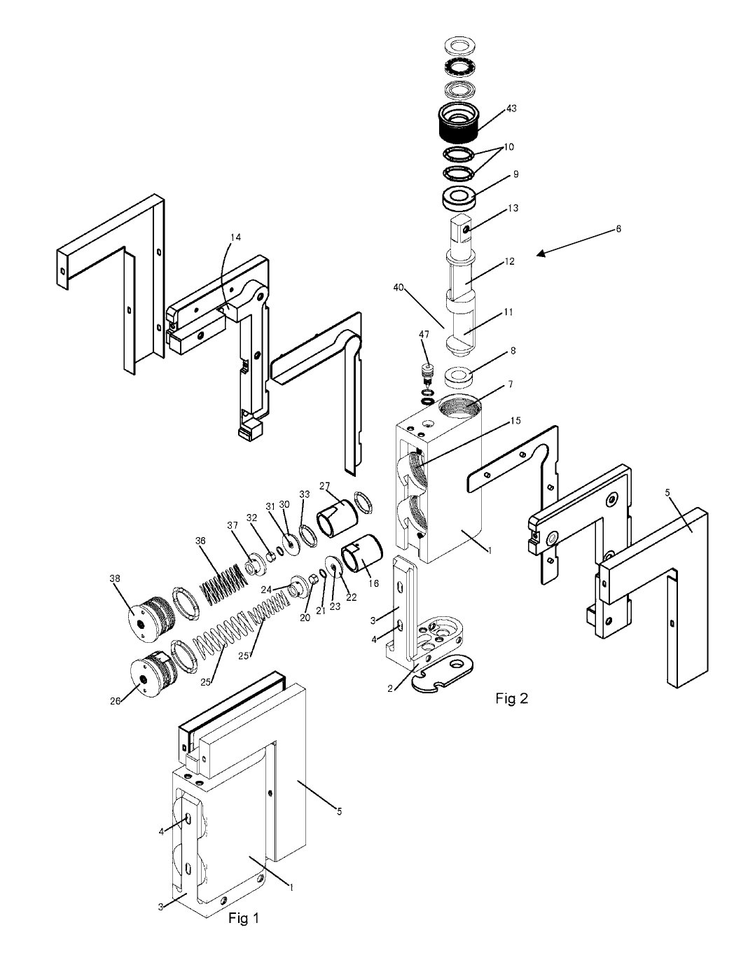

FIG. 1 shows a perspective view of a hinge in accordance with this invention. A housing (1) is mounted on a mounting block (2) having an upright member (3) with apertures (4) for bolts, screws or other fixing means (not shown).

A pair of clamps (5) are pivotally attached to the housing (1). The clamps (5) provide an aperture dimensioned to receive a glass plate.

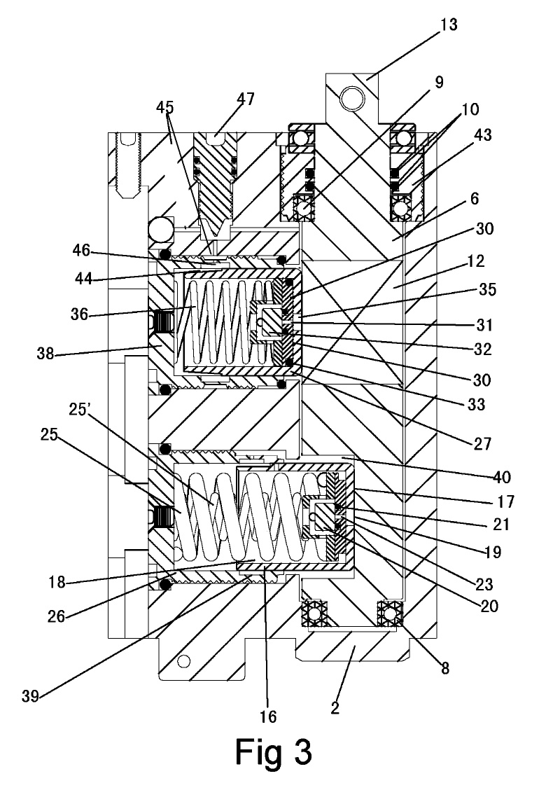

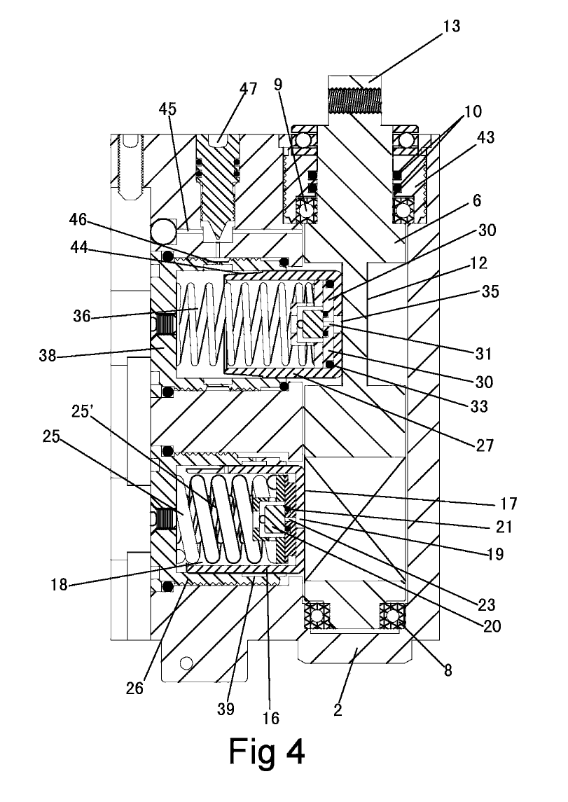

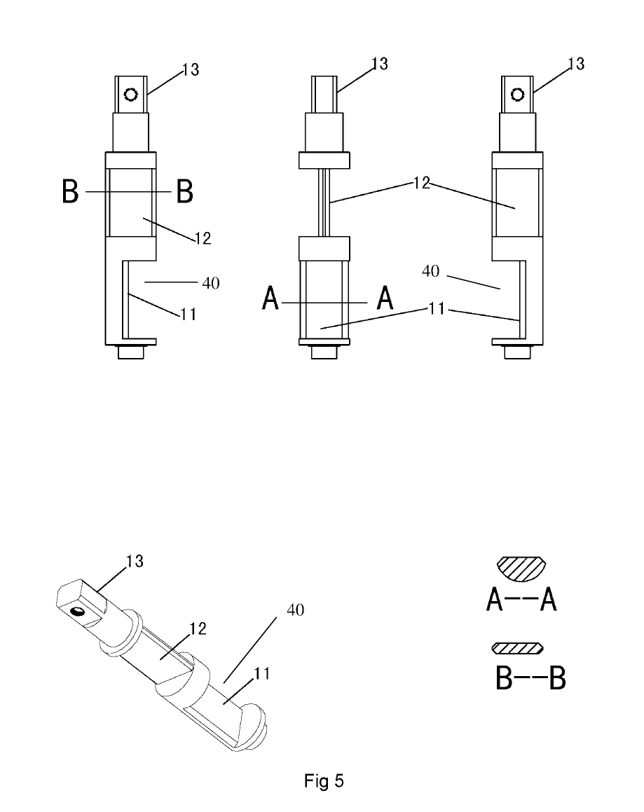

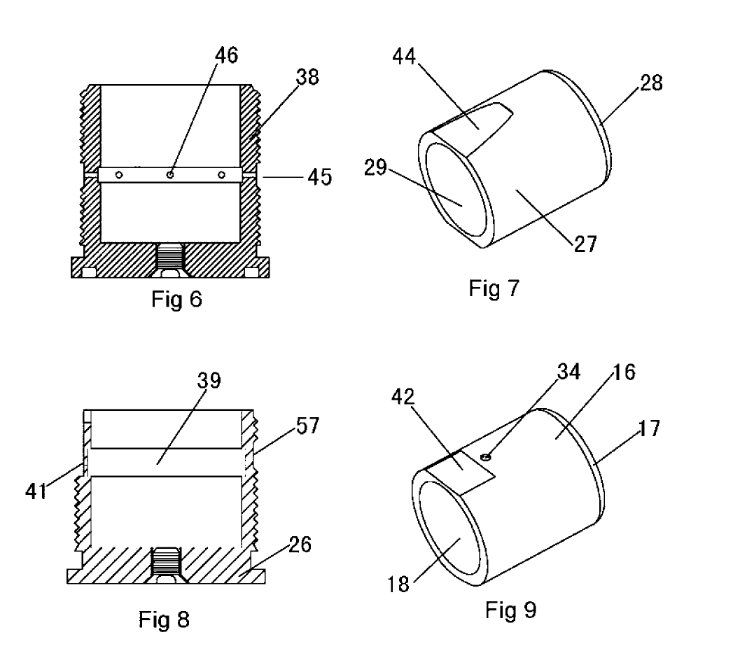

FIG. 2 is an exploded view of a first embodiment of the invention. FIGS. 3 and 4 show the hinge in cross sectional view in the open and closed positions.

A spindle (6) is received in a vertical bore (7) of the housing (1). The spindle is mounted on bearings (8, 9) sealed by gaskets (10) and a threaded sealing member (43) to allow rotation of the spindle in use.

The spindle is generally elongate and includes cut-away portions which define centering surfaces. A main centering surface (11) is located at a lower part of the spindle. Two diametrically opposed secondary centering surfaces (12) are disposed perpendicular to the main centering surface (11) and above the latter on the spindle. A cylindrical collar is located between the main and secondary centering surfaces. The surface of the collar cooperates with an internal cylindrical surface of the housing to maintain the spindle in alignment and to transmit the forces from the springs to the housing. This serves to prevent deformation of the spindle due to the forces applied by the pistons in use.

A rectangular head (13) allows coupling of the spindle to a correspondingly shaped rebate (14) in one of the clamping members so that the spindle and clamping members are constrained to rotate together in use.

Two biasing means are located in vertically spaced horizontally bores in the housing (1) arranged radially in respect to the axis of the spindle (6). A main biasing means is located in a lower bore (14) and a secondary biasing means is located in an upper bore (15).

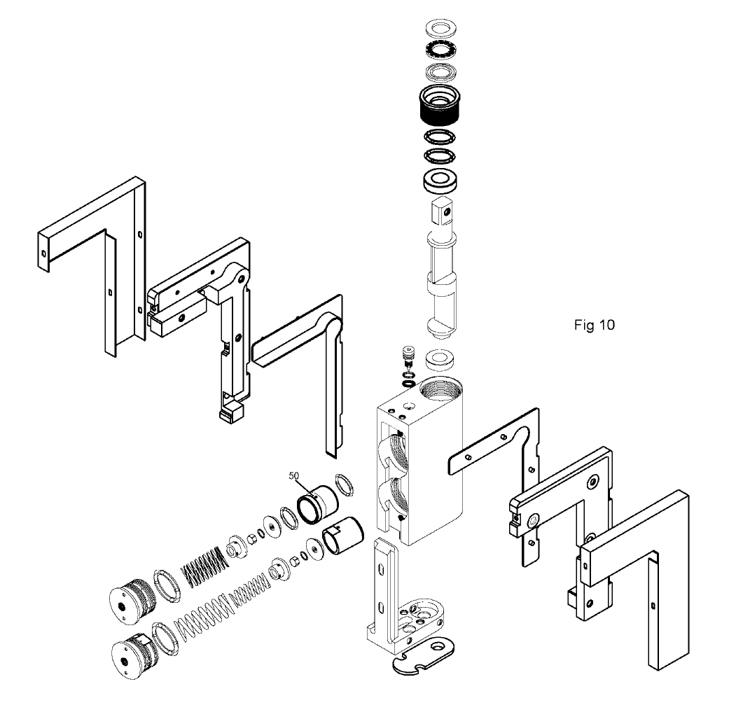

The main biasing means comprises a cylindrical piston (16) having a head (17) and an internal cavity (18) as shown in FIG. 9. The centre of the head (17) has an aperture (19) communicating with the cavity (18) by means of a captive non-return valve (20) cooperating with a gasket (21) located in disc (22). The disc (22) has an aperture (23) dimensioned to control the rate of oil flow in use of the hinge. A spring seat (24) carries a pair of springs (25, 25′). The distal ends of the springs remote from the spindle are received in a cylindrical sleeve (26). The pair of springs (25, 25′) exert an axial force to urge the piston (16) towards the centering surface (11) of the spindle. The pair of springs (25,25′) are selected to provide an even extension force over their operating range.

A secondary biasing means comprises a secondary piston (27) having a hollow cylindrical body and a head (28) and defining an internal cavity (29) as shown in FIG. 7. A disc (30) having a central aperture (31) cooperates with a non-return valve member (32). The disc (30) is sealed by a gasket (33). The aperture (31) in the disc (30) serves to regulate flow of oil through aperture (35) in the head of the piston. A helical spring (36) engages a spring seat (37) to urge the piston (27) in engagement with the spindle (6).

In a similar way to the main biasing means, a sleeve (38) has a cylindrical bore to receive the cylindrical piston body (27) permitting sliding movement of the piston in a radial direction with respect to the spindle axis.

As shown in FIG. 8, the sleeve (26) of the main biasing member has an inwardly facing annular channel (39) communicating by means of apertures (41) with the cavity (40) defined by the main centering surface (11) of the spindle. A cut-away portion (42) on the exterior of the cylindrical body (16) of the piston communicates with the channel (39) and aperture (57) when the piston is extended towards the spindle so that the head (17) engages the main centering surface (11). In this position oil can flow from the internal cavity (18) of the piston (17) through the cut away portion (42) or hole (34), channel (39), aperture (57) and into the cavity (40) surrounding the head of the piston. During the centering of the spindle in the closed position, as piston (16) is extended by action of spring (25), oil contained in the cavity (40) of the spindle passes through the aperture (23) and non-return valve (20) into the internal cavity (18) of the piston. During the return stroke as the piston is compressed into the sleeve (26) the non-return valve (20) is closed and oil passes through the cut-away portion (42) annular channel (39) and apertures (41) to return into the cavity (40), the volume of which increases as the spindle is rotated in use.

The upper secondary piston arrangement serves to damp the closing motion of the hinge. A sleeve (38) having a cylindrical bore to receive piston (27). The piston (27) has a head (28) and internal cavity (29). A cut-away portion (44) is provided at the distal end of the cylindrical piston body remote from the head and the spindle. A spring (36) urges the piston towards the spindle. As rotation of the spindle causes retraction of the piston into the sleeve as shown in FIG. 3, the non-return valve (32) closes the aperture (31) so that oil is driven from the distal end of the piston through the cut-away portion (44), apertures (46) and annular channel (45), past needle valve (47), allowing the oil to circulate into the cavity adjacent the spindle and particularly the cavity formed by centering surface (12). Adjustment of the needle valve (47) controls the maximum rate of flow of oil to provide a desired damping effect suitable for the weight of the glass door or other factors. Rotation of the spindle and centering surface (12) allows the piston to extend and simultaneously forces oil through the non-return valve into the piston cavity for another cycle.

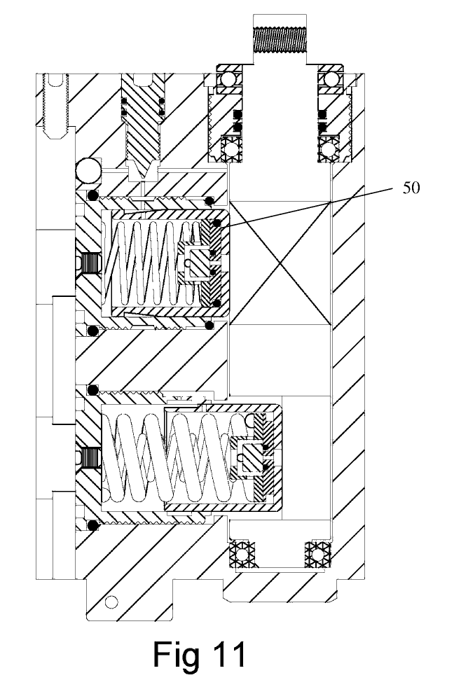

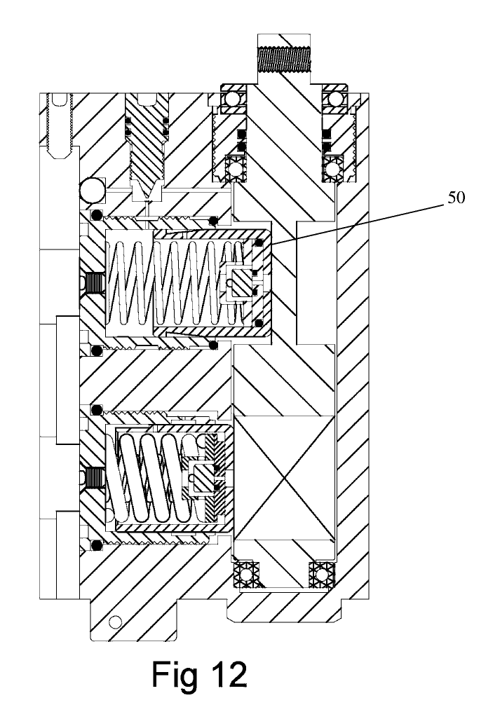

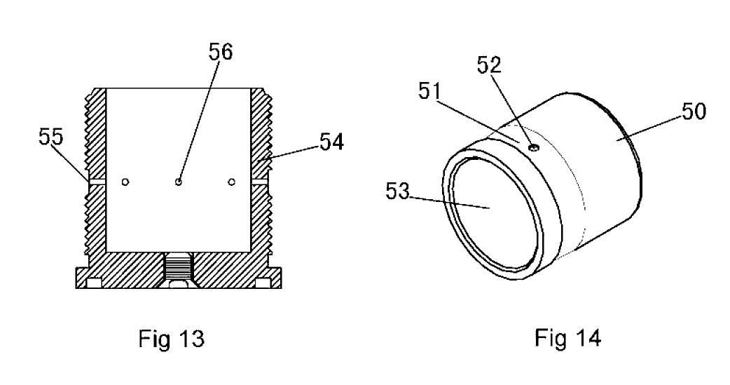

FIGS. 10 to 14 illustrate an alternative embodiment of the invention wherein the configuration of the upper secondary piston is modified to provide a cut-away portion at the distal end of the piston. Reference numerals for components which are the same as the previous embodiment are omitted for clarity. The piston body (50) of the secondary biasing means is provided with an annular channel (51) and an aperture (52) communicating with the interior cavity (53) of the piston as shown in FIG. 14. In other respects the construction of the hinge is the same as shown in the first embodiment. In this embodiment the sleeve (54) has an outer annular channel (55) with apertures (56) communicating with the interior cylindrical bore as shown in FIG. 13.

While the present invention has been illustrated and described with respect to a particular embodiment thereof, it should be appreciated by those of ordinary skill in the art that various modifications to this invention may be made without departing from the spirit and scope of the present.

What is claimed is:

1. A glass door hinge having an internal door stop arrangement comprises:
a housing;
a mount for coupling the housing to a support member;
a pair of clamps;
an axial spindle; and
a plurality of biasing members arranged to engage the spindle to return the clamps to one of a plurality of positions selected from a closed position and one or more opened positions;
wherein the spindle has a plurality of centering surfaces;
each biasing member being arranged to apply a force to a respective centering surface to centre the clamps in one or more of said positions.

2. The hinge as claimed in claim 1 including damping means for damping the opening and closing movements of the hinge.

3. The hinge as claimed in claim 1 whereas the biasing means includes a damping arrangement to limit the rate of rotation of the hinge.

4. The hinge as claimed in claim 1 including a main biasing member and a main spring arranged to engage a main centering surface to urge the door into a closed position; and
a secondary biasing member and a secondary spring arranged to engage one of two secondary centering surfaces to urge the door into one of two opened positions.

5. The hinge as claimed in claim 1 wherein the main and secondary biasing members are located in horizontal bores arranged in vertical spaced relation extending radially relative to the spindle axis.

6. The hinge as claimed in claim 1, wherein the two opened positions of the hinge are perpendicular to the closed position, and the two secondary centering surfaces are of orthogonal to the main centering surface and are diametrically opposed to each other.

7. The hinge as claimed in claim 1, wherein each biasing member comprises a piston mounted in a cylindrical bore for movement radially with respect to the spindle.

8. The hinge as claimed in claim 7, comprising a hollow cylindrical member having a head arranged to engage a respective centering surface and having a cavity, a spring being located in the cavity to urge piston outwardly of the bore.

9. The hinge as claimed in claim 1, wherein the spindle is mounted in a vertical guideway in the housing, the guideway communicating with passageways within which the biasing members are located to allow circulation of hydraulic fluid or other oil during actuation of the hinge.

10. The hinge as claimed in claim 1 wherein the piston and sleeve each provide a damping arrangement.

11. The hinge as claimed in claim 1 wherein the piston and sleeve are dimensioned to provide a sliding fit.

12. The hinge as claimed in claim 1 wherein a channel is provided to allow oil to pass from the piston cavity to a cavity within the housing as the piston is compressed into the sleeve.

13. The hinge as claimed in claim 12 including an adjustable valve to regulate a maximum flow of oil.

14. The hinge as claimed in claim 13 including a needle valve having a screw thread to control the dimension of the passageway leading from the piston and cylinder into a passageway in the hinge housing.

15. The hinge as claimed in claim 1 wherein the piston of each biasing means includes a non-return valve arranged to permit a flow of oil into the cavity as the piston and cylinder expand.

16. The hinge as claimed in claim 1 wherein the main piston is provided with one or more apertures to allow a flow of oil from the cavity compression of the piston.

17. The hinge as claimed in claim 1 wherein the piston has a head and a cylindrical body dimensioned to be slidably received within a cylindrical bore of the sleeve, and one or more apertures provided at a predetermined axial distance from the head, the aperture or apertures being blocked by the sleeve after sliding the body by a predetermined distance into the cylindrical sleeve.

18. The hinge as claimed in claim 1 wherein a cut-away portion is provided at the distal end of the cylindrical body.

19. A glass door hinge spindle comprising an axial shaft including an attachment for engagement to a door so that the spindle and door are constrained to rotate together in use;
wherein the spindle further comprises:
a main centering surface parallel to the axis of the shaft and two secondary centering surfaces orthogonal to the main centering surface, wherein the two secondary centering surfaces extend axially of the shaft in diametrically opposed relation.
